(19) United States
(12) Patent Application Publication
(10) Pub. No.: US 2003/0062842 A1
(43) Pub. Date: Apr. 3, 2003

(54) Measuring chip and method of manufacture thereof

(76) Inventor: Yoshimitsu Nomura, Saitama-ken (JP)

Correspondence Address: CLIFFORD CHANCE US LLP, 200 PARK AVENUE, NEW YORK, NY, 10166, US

(21) Appl. No.: 10/253,309

(22) Filed: Sep. 24, 2002

(30) Foreign Application Priority Data
Sep. 28, 2001 (JP) 2001-299569

(51) Int. Cl. H05B 41/36

(52) U.S. Cl. 315/149

(57) ABSTRACT

A method of manufacturing a measuring chip which comprises a dielectric block, and a thin film layer, formed on one surface of the dielectric block, for placing a sample thereon. The dielectric block is formed from resin as a single block whose section parallel to the one surface is a polygon. The single block includes an entrance surface through which a light beam enters the dielectric block, an exit surface through which the light beam emerges from the dielectric block, and the one surface on which the thin film layer is formed. The dielectric block is formed by injection molding, using two half molds whose mating faces are positioned outside two apex angles of the polygon which face each other across the center of the polygon.

### BACKGROUND OF THE INVENTION

1. Field of the Invention

The present invention relates to a measuring chip that is employed in a surface plasmon resonance measurement apparatus for quantitatively analyzing the properties of a substance in a liquid sample by utilizing surface plasmon excitation. The present invention also relates to a method of manufacturing such a measuring chip.

2. Description of the Related Art

In metals, if free electrons are caused to vibrate in a group, a compression wave called a plasma wave will be generated. The compression wave, generated in the metal surface and quantized, is called a surface plasmon.

There are various kinds of surface plasmon resonance measurement apparatuses for quantitatively analyzing a substance in a liquid sample by taking advantage of a phenomenon that the surface plasmon is excited by light waves. Among such apparatuses, one employing the “Kretschmann configuration” is particularly well known (e.g., see Japanese Unexamined Patent Publication No. 6(1994)-167443).

The surface plasmon resonance measurement apparatus employing the aforementioned “Kretschmann configuration” includes (1) a dielectric block formed into the shape of a prism; (2) a metal film, formed on a surface of the dielectric block, for placing a sample thereon; (3) a light source for emitting a light beam; (4) an optical system for making the light beam enter the dielectric block so that a condition for total internal reflection is satisfied at the interface between the dielectric block and the metal film and that various angles of incidence, including a surface plasmon resonance condition, are obtained; and (5) photodetection means for measuring the intensity of the light beam totally reflected at the interface to detect surface plasmon resonance.

In order to obtain various angles of incidence in the aforementioned manner, a relatively thin light beam may be deflected to strike the above-mentioned interface, or relatively thick convergent or divergent rays may strike the interface so that they have components which are incident at various angles. In the former, a light beam whose reflection angle varies with the deflection thereof can be detected by a small photodetector that is moved in synchronization with the deflection, or by an area sensor extending in the direction where the angle of reflection varies. In the latter, on the other hand, rays reflected at various angles can be detected by an area sensor extending in a direction where all the reflected rays can be received.

In the above-described surface plasmon resonance measurement apparatus, if a light beam strikes the thin film layer at a specific incidence angle θₛₚ greater than a critical incidence angle at which total internal reflection (TIR) takes place, an evanescent wave having an electric field distribution is generated in a liquid sample in contact with the thin film layer. The evanescent wave excites the above-described surface plasmon at the interface between the thin film layer and the liquid sample. When the wave vector of the evanescent wave is equal to the wave number of the surface plasmon and therefore the wave numbers between the two are matched, the evanescent wave resonates with the surface plasmon and the light energy is transferred to the surface plasmon, whereby the intensity of the light totally reflected at the interface between the dielectric block and the metal film drops sharply. This sharp intensity drop is generally detected as a dark line by the above-described photodetection means.

Note that the aforementioned resonance occurs only when an incident light beam is a p-polarized light beam. Therefore, in order to make the resonance occur, it is necessary to make settings in advance so that a light beam can strike the aforementioned interface as a p-polarized light beam.

If the wave number of the surface plasmon is found from a specific incidence angle θₛₚ at which attenuated total reflection (hereinafter referred to as ATR) takes place, the dielectric constant of a sample to be analyzed can be calculated by the following Equation:

$${K}_{s p} ( ω ) = \frac{ω}{c} \sqrt{\frac{{ϵ}_{m} ( ω ) {ϵ}_{s}}{{ϵ}_{m} ( ω ) + {ϵ}_{s}}}$$

where Kₛₚ represents the wave number of the surface plasmon, ω represents the angular frequency of the surface plasmon, c represents the speed of light in vacuum, and εₘ and εₛ represent the dielectric constants of the metal and the sample, respectively.

If the dielectric constant εₛ of the sample is found, the concentration of a specific substance in the sample is found based on a predetermined calibration curve, etc. As a result, the specific substance can be quantitatively analyzed by finding the specific incidence angle θₛₚ at which the intensity of reflected light drops sharply.

In the conventional surface plasmon resonance measurement apparatus employing the aforementioned system, the metal film on which a sample is placed must be exchanged each time a measurement is made. Because of this, the metal film is fixed on a first dielectric block in the form of a plate, and a second dielectric block in the form of a prism is provided as an optical coupler for making the aforementioned total internal reflection occur. The first dielectric block is united with a surface of the second dielectric block. The second dielectric block is fixed with respect to an optical system. The first dielectric block and the metal film are used as a measuring chip. In this manner, the measuring chip can be exchanged every time a measurement is made.

In addition, a leaky mode measurement apparatus is known as a similar measurement apparatus making use of ATR (for example, see “Spectral Research,” Vol. 47, No. 1 (1998), pp. 21 to 23 and pp. 26 to 27). This leaky mode measurement apparatus includes (1) a dielectric block formed into the shape of a prism; (2) a cladding layer formed on a surface of the dielectric block; (3) an optical waveguide layer, formed on the cladding layer, for placing a sample thereon; (4) a light source for emitting a light beam; (5) an optical system for making the light beam enter the dielectric block at various angles of incidence so that a condition for total internal reflection is satisfied at the interface between the dielectric block and the cladding layer; and (6) photodetection means for measuring the intensity of the light beam totally reflected at the interface to detect the excited state of a waveguide mode, i.e., the state of ATR.

In the above-described leaky mode measurement apparatus, if a light beam strikes the cladding layer through the dielectric block at incidence angles greater than a critical incidence angle at which total internal reflection (TIR) takes place, the light beam is transmitted through the cladding layer. Thereafter, in the optical waveguide layer formed on the cladding layer, only light with a specific wave number, incident at a specific incidence angle, propagates in a waveguide mode. If the waveguide mode is excited in this manner, most of the incident light is confined within the optical waveguide layer, and consequently, ATR occurs in which the intensity of light totally reflected at the aforementioned interface drops sharply. The wave number of the light propagating through the optical waveguide layer depends upon the refractive index of the sample on the optical waveguide layer. Therefore, the refractive index of the liquid sample and the properties of the liquid sample related to the refractive index can be analyzed by finding the above-described specific incidence angle θₛₚ at which ATR takes place.

In the leaky mode measurement apparatus, as with the aforementioned surface plasmon resonance measurement apparatus, a first dielectric block is fixed with respect to the optical system, and the cladding layer and the optical waveguide layer are formed on a second dielectric block and used as a measuring chip. When a sample is exchanged, only the measuring chip can be exchanged.

However, in the case where the conventional measuring chip which is exchangeable is employed, a gap occurs between the first dielectric block and the second dielectric block and the refractive index becomes discontinuous. To prevent the discontinuity, it is necessary that the two dielectric blocks be united through an index-matching solution. The operation of uniting the two dielectric blocks in a body is fairly difficult, and consequently, the conventional measuring chip is not easy to handle in making a measurement. There are cases where measurement is automated by automatically loading a plurality of measuring chips into a turret, then rotating the turret, and automatically supplying the measuring chips to a measuring position where a light beam enters the measuring chip. In such a case, the loading and removal of the measuring chips are time-consuming. As a result, the efficiency of the automatic measurement is reduced. In addition, there is a possibility that the conventional measuring chip will have a bad influence on the environment, because it uses an index-matching solution.

In view of the circumstances mentioned above, there has been proposed a surface plasmon resonance measuring chip that can be easily exchanged without using an index-matching solution (Japanese Unexamined Patent Publication No. 2001-92666).

This measuring chip comprises (1) a dielectric block; (2) a thin film layer, formed on a surface of the dielectric block, for placing a sample thereon; (3) a light source for emitting a light beam; (4) an optical system for making the light beam enter the dielectric block so that a condition for total internal reflection is satisfied at an interface between the dielectric block and the thin film layer and that the light beam has incident components at various angles; and (5) photodetection means for detecting the intensity of the light beam totally reflected at the interface to detect the state of ATR. The dielectric block is formed as a single block, which includes an entrance surface through which the light beam enters the dielectric block, an exit surface through which the light beam emerges from the dielectric block, and a surface on which the thin film layer is formed. The thin film layer is integrated with the dielectric block.

Note that in the case where the measuring chip is used in the above-described surface plasmon resonance measurement apparatus, the above-described thin film layer is constructed of a metal film. In the case where it is used in a leaky mode measurement apparatus, the thin film layer is constructed of a cladding layer and an optical waveguide layer.

In addition, the dielectric block constituting the measuring chip preferably has a sample holding portion for holding a sample on the thin metal film, formed by surrounding the space above the thin metal film from the sides thereof.

The above-described dielectric block, incidentally, is generally formed into the shape of a truncated quadrangular pyramid, a square pole (the shape of a section parallel to one surface on which the thin film layer is formed is a polygon such as a tetragon), etc., by injection-molding resin. However, in many of the measuring chips comprising the dielectric block of resin, the light-transmitting areas of the entrance surface and exit surface of the dielectric block have poor optical characteristics (flatness, etc.)

### SUMMARY OF THE INVENTION

The present invention has been made in view of the circumstances mentioned above. Accordingly, it is an object of the present invention to provide a measuring chip equipped with a resin dielectric block in which the light-transmitting areas of the entrance and exit surfaces thereof have good optical characteristics. Another object of the present invention is to provide a measuring-chip manufacturing method which is capable of obtaining such a resin dielectric block.

To achieve the above-described objects and in accordance with the present invention, there is provided a first method of manufacturing a measuring chip which comprises

a dielectric block, and

a thin film layer, formed on one surface of the dielectric block, for placing a sample thereon;

the measuring chip being employed in a measurement apparatus which utilizes attenuated total reflection and comprises

a light source for emitting a light beam,

an optical system for making the light beam enter the dielectric block at various angles of incidence so that a condition for total internal reflection is satisfied at an interface between the dielectric block and the thin film layer, and

photodetection means for detecting the intensity of the light beam totally reflected at the interface to detect attenuated total reflection;

the dielectric block being formed from resin as a single block whose section parallel to the one surface is a polygon, and which includes an entrance surface through which the light beam enters the dielectric block, an exit surface through which the light beam emerges from the dielectric block, and the one surface on which the thin film layer is formed; and

the thin film layer being integrated with the dielectric block; implemented by the step of:

forming the dielectric block by injection molding, using two half molds whose mating faces are positioned outside two apex angles of the polygon which face each other across the center of the polygon.

Further in accordance with the present invention, there is provided a second method of manufacturing a measuring chip which comprises

a dielectric block, and

a thin film layer comprising a metal film, formed on one surface of the dielectric block, for placing a sample thereon;

the measuring chip being employed in a measurement apparatus which utilizes attenuated total reflection and comprises

a light source for emitting a light beam,

an optical system for making the light beam enter the dielectric block at various angles of incidence so that a condition for total internal reflection is satisfied at an interface between the dielectric block and the metal film, and

photodetection means for detecting the intensity of the light beam totally reflected at the interface to detect attenuated total reflection due to surface plasmon resonance;

the dielectric block being formed from resin as a single block whose section parallel to the one surface is a polygon, and which includes an entrance surface through which the light beam enters the dielectric block, an exit surface through which the light beam emerges from the dielectric block, and the one surface on which the metal film is formed; and

the thin film layer being integrated with the dielectric block; implemented by the step of:

forming the dielectric block by injection molding, using two half molds whose mating faces are positioned outside two apex angles of the polygon which face each other across the center of the polygon.

Further in accordance with the present invention, there is provided a third method of manufacturing a measuring chip which comprises

a dielectric block, and

a thin film layer comprising a cladding layer formed on one surface of the dielectric block, and an optical waveguide layer, formed on the cladding layer, for placing a sample thereon;

the measuring chip being employed in a measurement apparatus which utilizes attenuated total reflection and comprises

a light source for emitting a light beam,

an optical system for making the light beam enter the dielectric block at various angles of incidence so that a condition for total internal reflection is satisfied at an interface between the dielectric block and the cladding layer, and

photodetection means for detecting the intensity of the light beam totally reflected at the interface to detect attenuated total reflection due to the excitation of a waveguide mode at the optical waveguide layer;

the dielectric block being formed from resin as a single block whose section parallel to the one surface is a polygon, and which includes an entrance surface through which the light beam enters the dielectric block, an exit surface through which the light beam emerges from the dielectric block, and the one surface on which the cladding layer is formed,

the thin film layer being integrated with the dielectric block; implemented by the step of:

forming the dielectric block by injection molding, using two half molds whose mating faces are positioned outside two apex angles of the polygon which face each other across the center of the polygon.

In the above-described manufacturing methods of the present invention, it is particularly preferable that the polygon be a regular polygon in which the number of sides is an even number.

In the above-described manufacturing methods of the present invention, the resin may comprise a cycloolefin polymer.

A measuring chip according to the present invention is manufactured by the above-described methods. In the measuring chip of the present invention, it is desirable that the dielectric body have a sample holding portion for holding a sample on the thin film layer, formed by surrounding the space above the thin film layer from the sides thereof.

Now, a description will be given of the cause of the aforementioned problem found in prior art.

FIG. 3 shows a measuring chip that is employed in a surface plasmon resonance measurement apparatus. As shown in the figure, the measuring chip 10 has a transparent dielectric block 11, a metal film 12 formed on one surface 11a of the dielectric block 11, and a sample holding portion 13 for holding a sample on the metal film 12. The dielectric block 11 is formed, for example, into the shape of a truncated quadrangular pyramid. The metal film 12 is made of gold, silver, copper, aluminum, etc. The dielectric block 11 is formed as a single block, which includes the surface 11a on which the metal film 12 is formed, an entrance surface 11c through which a measuring light beam enters the dielectric block 11, and an exit surface 11b through which the light beam emerges from the dielectric block 11.

In the measuring 10 of the present invention, the dielectric block 11 and the sample holding portion 13 are formed integrally with each other, using transparent resin. Preferred examples are a cycloolefin polymer, polymethylmethacrylate (PMMA), polycarbonate, a non-crystalline polyolefin, etc. An extremely preferred example is “ZEONEX 330R” (manufactured by Japan Zeon) which is a cycloolefin polymer. In the present invention, a sensing medium 14 is fixed on the metal film 12. The reason for that will be described later.

The resin dielectric block 11 with the above-described shape has conventionally been formed by injection molding, using two half molds 5a and 5b. The sections of the two half molds parallel to one surface 11a of the dielectric block 11 are shown in FIG. 5. That is, the mating faces H of the molds 5a and 5b are positioned on the exterior of two side surfaces of the four side surfaces of the dielectric block 11.

In the case where the two half molds 5a and 5b with the above-described mating faces H are employed, the molds 5a and 5b are provided tapered portions called a “pulling taper” so that the dielectric block 11 molded can be easily pulled out from the molds 5a and 5b. Although the angle of the pulling taper is actually about 1 to 3 degrees, it is exaggeratedly shown by θ in FIG. 5. Therefore, in the figure, the section of a portion of the dielectric block 11 is a hexagon, but it is practically a square.

If each of the two half molds has the pulling taper, when the maximum outer dimension A of the dielectric block 11 is determined by a standard, etc., the maximum dimension of the entrance surface 11c and exit surface 11b (a pulling taper cannot be formed at these surfaces) become A′, smaller than the maximum dimension A. The light-transmitting areas of the entrance surface 11c and exit surface 11b must be set great to assure the stability of surface plasmon resonance measurements. Particularly, when the dielectric block 11 is small, an area with a width close to the above-described maximum dimension A is set as a light-transmitting area.

Because of this, the light-transmitting areas of the entrance and exit surfaces 11c and 11b extend to the corners of the dielectric block 11 in which the problem of shrinkage is liable to occur when injection molding is performed. As a result, the optical characteristics of the light-transmitting areas are degraded.

In the present invention, the dielectric block 11 with the same shape is formed by injection molding, using two half molds 84a and 84b. The sections of the two half molds parallel to one surface 11a of the dielectric block 11 are shown in FIG. 6. That is, although the sections of the two half molds 84a and 84b parallel to one surface 11a have a regular square shape, injection molding is performed by the two half molds 84a and 84b whose mating faces H are positioned outside two apex angles of the regular square which face each other across the center O of the regular square.

If the two half molds 84a and 84b are employed, the molded dielectric block 11 can be easily pulled out from the molds 84a and 84b without forming the above-describe pulling tapers. If the pulling tapers are not formed, the maximum dimension A of the dielectric block becomes the maximum dimension of the entrance surface 11c and exit surface 11b. Therefore, the width of the entrance surface 11c and exit surface 11b becomes greater than the case where the molds 5a and 5a are employed. As a result, the light-transmitting areas of the entrance and exit surfaces 11c and 11b are prevented from extending to the corners of the dielectric block 11 in which the problem of shrinkage is liable to occur when injection molding is performed. Thus, the light-transmitting areas have good optical characteristics.

While the present invention has been described with reference to the surface plasmon resonance measuring chip whose section parallel to one surface 11a is a regular square, the invention is also applicable to a polygon other than a regular square. Furthermore, the present invention is applicable to the case where measuring chips to be employed in the aforementioned leaky mode measurement apparatus are manufactured. As with the case of the surface plasmon resonance measuring chip, the same advantages can be obtained.

### BRIEF DESCRIPTION OF THE DRAWINGS

The present invention will be described in further detail with reference to the accompanying drawings wherein:

FIG. 1 is a perspective view showing a surface plasmon resonance measurement apparatus that employs surface plasmon resonance measuring chips manufactured by a manufacturing method of the present invention;

FIG. 2 is a part-sectional side view showing the surface plasmon resonance measurement apparatus of FIG. 1;

FIG. 3 is a perspective view showing the surface plasmon resonance measuring chip manufactured by the manufacturing method of the present invention shown in FIG. 1;

FIG. 4 is a graph showing the relationship between the incidence angle at which a light beam enters the measuring chip, and the intensity of the light beam reflected at the measuring chip;

FIG. 5 is a plan sectional view showing a two-piece mold for molding a measuring chip, employed in a conventional manufacturing method;

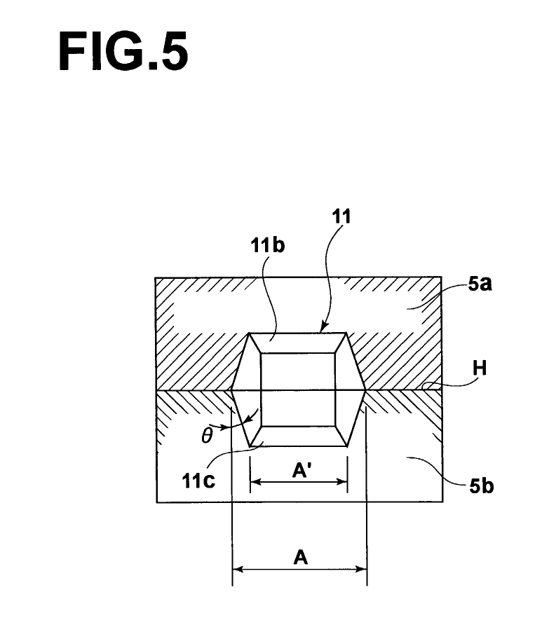

FIG. 6 is a plan sectional view showing a two-piece mold for molding a measuring chip, employed in the manufacturing method of the present invention;

FIG. 7 is a side sectional view showing an apparatus for manufacturing the measuring chip in accordance with the manufacturing method of the present invention; and

FIG. 8 is a part-sectional view of a leaky mode measurement apparatus which employs measuring chips different from the measuring chips shown in FIG. 1, manufactured by the manufacturing method of the present invention.

### DESCRIPTION OF THE PREFERRED EMBODIMENTS

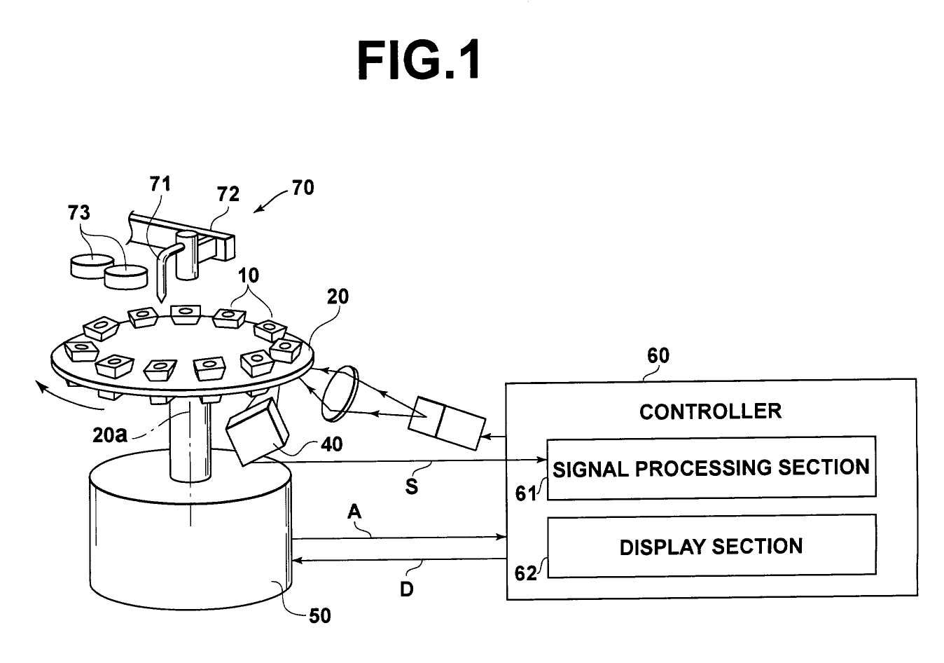

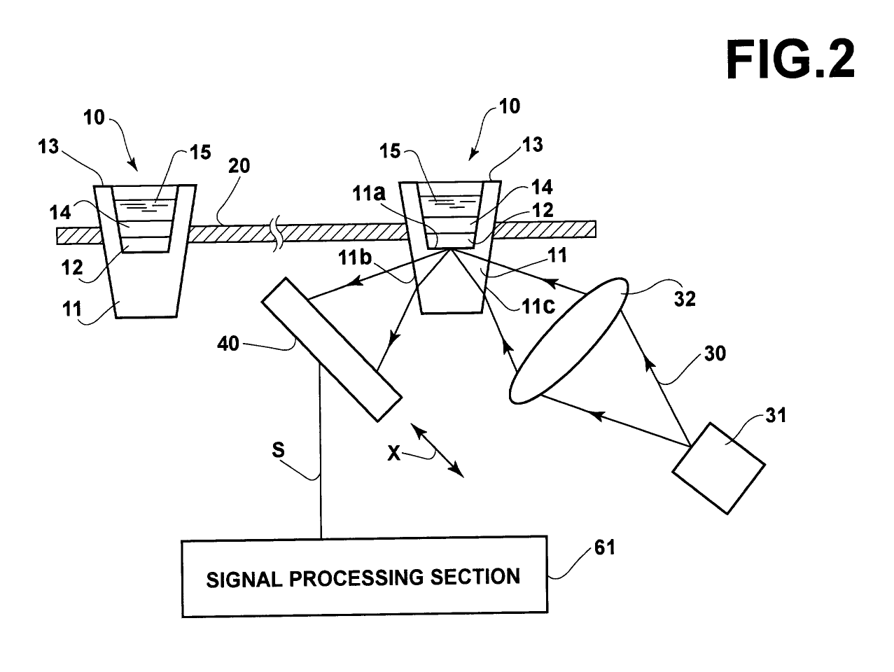

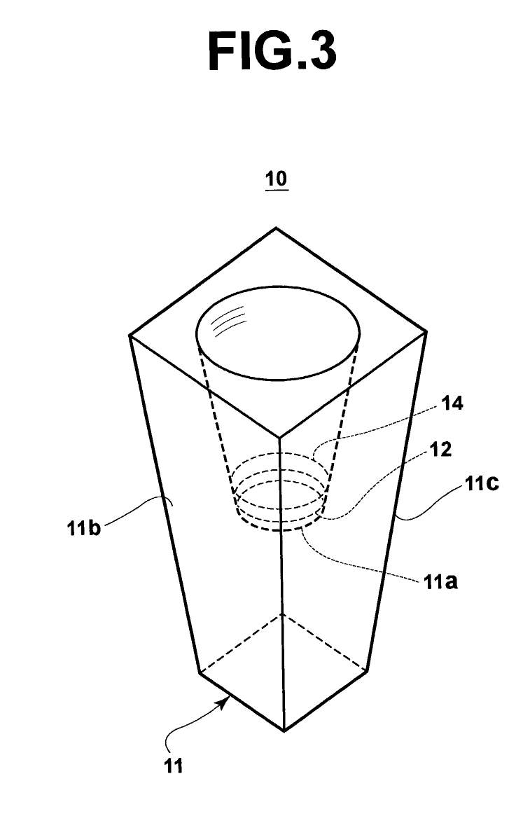

Referring now in greater detail to the drawings and initially to FIG. 1, there is shown a surface plasmon resonance measurement apparatus which employs surface plasmon resonance measuring chips (hereinafter referred to simply as measuring chips) 10 manufactured by a manufacturing method of the present invention. FIG. 2 shows a side view of the essential parts of this apparatus. FIG. 3 shows a perspective view of the measuring chip 10. Initially, the surface plasmon resonance measurement apparatus will be described.

As illustrated in FIG. 1, the surface plasmon resonance measurement apparatus has a turntable 20 for supporting a plurality of measuring chips 10. The apparatus also has a laser light source (e.g., a semiconductor laser) 31 for emitting a measuring light beam (e.g., a laser beam) 30, a condenser lens 32 constituting an optical incidence system, and a photodetector 40. The surface plasmon resonance measurement apparatus further has supporting-body drive means 50 for rotating the turntable 20 intermittently, a controller 60, and an automatic sample supply mechanism 70. The controller 60 controls the supporting-body drive means 50, and also performs a process described later in response to a signal S output from the photodetector 40.

The measuring chip 10, as shown in FIGS. 2 and 3, is constructed of a transparent dielectric block 11, a metal film 12, and a sample holding portion 13. The dielectric block 11 is formed, for example, into the shape of a truncated quadrangular pyramid. The metal film 12 is formed on the top surface of the dielectric block 11 and made of silver, copper, aluminum, etc. The sample holding portion 13 is formed on the dielectric block 11 so that a sample is held on the metal film 12. The dielectric block 11 is formed as a single block, which includes a top surface 11a (interface to be described later) on which the metal film 12 is formed; an entrance surface 11c through which the light beam 30 enters; and an exit surface 11b from which the light beam 30 emerges. In the sample holding portion 13, a liquid sample 15, for instance, is stored as described later.

The dielectric block 11 and the sample holding portion 13, which constitute the measuring chip 10, are integrally formed from a transparent resin. The measuring chip 10 is exchangeable with respect to the turntable 20. To make the measuring chip 10 exchangeable, it maybe detachably fitted in a through aperture formed in the turntable 20, for example. Preferred examples of the transparent resin are a cycloolefin polymer, PMMA, polycarbonate, a non-crystalline polyolefin, etc. In this embodiment, a sensing medium 14 is fixed on the metal film 12. The reason for that will be described later. It is desirable that the refractive index of a resin material which forms the dielectric block 11 be in the range of about 1.45 to 2.5. The reason is that in this refractive index range, practical surface plasmon resonance (SPR) angles are obtainable.

The turntable 20 is constructed so that a plurality of measuring chips 10 is supported at equiangular intervals on a circle with respect to the axis of rotation 20a. In this embodiment, 11 (eleven) measuring chips 10 are employed. The supporting-body drive means 50 is constructed of a stepping motor or the like, and is rotated intermittently at equiangular intervals equal to the pitch between the measuring chips 10.

The condenser lens 32, as shown in FIG. 2, is used to collect the light beam 30 emitted from the light source 31. The collected light beam 30 enters the dielectric block 11 at the entrance surface 11c and converges at the interface 11a between the dielectric block 11 and the metal film 12 so that various angles of incidence are obtained. That is, in the range of the incidence angles, a total internal reflection (TIR) condition for the light beam 30 is satisfied at the interface 11a, and surface plasmon resonance is able to take place. Note that for convenience, the interface between the dielectric block 11 and the metal film 12 is represented by the same reference numeral 11a as the top surface 11a of the dielectric block 11.

The light beam 30 strikes the interface 11a as p-polarized light. For this reason, it is necessary to dispose the laser light source 31 so that the polarization direction thereof becomes a predetermined direction. Alternatively, the direction of polarization of the light beam 30 may be controlled with a wavelength plate, a polarizing plate, etc.

The photodetector 40 is constructed of a line sensor, which consists of a great number of light-receiving elements arrayed in a row and along the direction of arrow X in FIG. 2.

The controller 60 receives an address signal A representing a position where rotation of the supporting-body drive means 50 is stopped, from the supporting-body drive means 50. This controller 60 also outputs a drive signal D to actuate the supporting-body drive means 50, based on a predetermined sequence. The controller 60 includes a signal processing section 60 to which the output signal S from the photodetector 40 is input, and a display section 62 to which a signal from the signal processing section 61 is output.

The automatic sample supply mechanism 70 is constructed of a pipette 71 for suctioning and holding a predetermined quantity of a liquid sample, and means 72 for moving the pipette 71. The automatic sample supply mechanism 70 suctions and holds a liquid sample from a sample container 73 through the pipette 71, and supplies the liquid sample to the sample holding portion 13 of the measuring chip 10 being stopped at a predetermined position.

A description will hereinafter be given of how a sample is analyzed by the surface plasmon resonance measurement apparatus constructed as described above. The turntable 20 is rotated intermittently by the supporting-body drive means 50, as previously mentioned. When the turntable 20 is stopped, a sample 15 is supplied by the automatic sample supply mechanism 70 to the sample holding portion 13 of the measuring chip 10 being at a predetermined position.

If the turntable 20 is rotated a few times and stopped, the measuring chip 10 with the sample 15 in the sample holding portion 13 is located at a measuring position (see FIG. 2) where the light beam 30 enters the dielectric block 11. When the measuring chip 10 is held at the measuring position, the laser light source 31 is driven in response to a command from the controller 60. The light beam 30 emitted from the laser light source 31 is collected by the condenser lens 32 and strikes the interface 11a between the dielectric block 11 and the metal film 12 in a state of convergence. The light beam 30 totally reflected at the interface 11a is detected by the photodetector 40.

The light beam 30 has components that are incident on the interface 11a at various incidence angles θ, because it enters the dielectric block 11 in a state of convergence, as mentioned above. Note that these incidence angles θ are equal to or greater than a critical angle at which total internal reflection takes place. Therefore, the light beam 30 is totally reflected at the interface 11a, and has components that are reflected at various angles of reflection. The optical system, which includes the condenser lens 32, etc., may be constructed so that the light beam 30 strikes the interface 11a in a defocused state. In such a case, errors in the measurement of surface plasmon resonance (e.g., errors in the measurement of the position of the dark line) are averaged and therefore accuracy of measurement is enhanced.

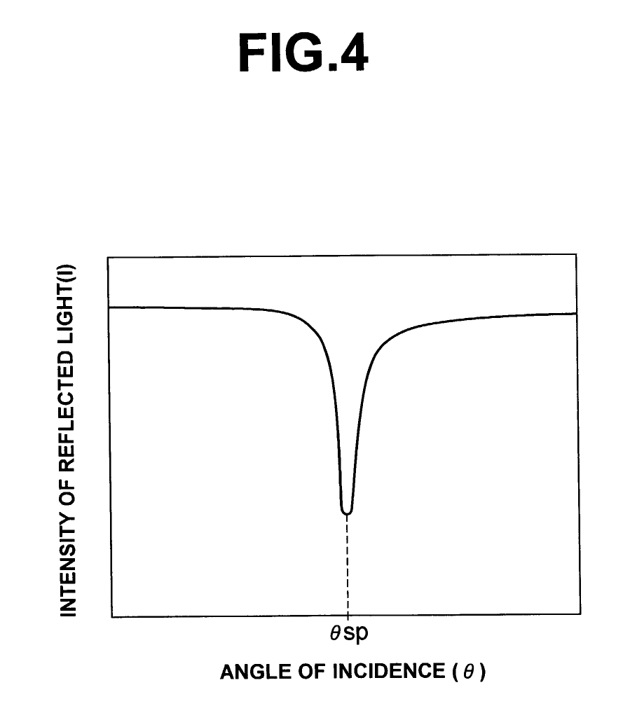

When the light beam 30 satisfies total internal reflection at the interface 11a, as described above, an evanescent wave propagates on the side of the metal film 12 through the interface 11a. And when the light beam 30 strikes the interface 11a at a specific incidence angle θₛₚ, the evanescent wave resonates with the surface plasmon excited at the surface of the metal film 12. Because of this, the intensity I of the reflected light drops sharply. The relationship between the specific incidence angle θₛₚ and the light intensity I is shown in FIG. 4.

Hence, the quantity of light detected by each light-receiving element is calculated from the light-quantity detection signal S output from the photodetector 40. Based on the calculated light quantity (i.e., based on the position of the light-receiving element that detected a dark line), the specific incidence angle θₛₚ (at which ATR occurs) is obtained. Therefore, according to previously obtained curves which represent the relationship between reflected-light intensity I and specific incidence angle θₛₚ, a specific substance in the sample 15 can be quantitatively analyzed. The result of analysis is displayed on the display section 62.

In the case where a single measurement is made on a single sample 15, the measurement is completed in the manner described above. Therefore, in this case, the measuring chip 10 on which a measurement was made is removed from the turntable 20 by hand or with automatic removal means. On the other hand, in the case where a plurality of measurements are made on a single sample 15, each of the measuring chips 10 is still supported by the turntable 20 even after the first measurement. After one full revolution of the turntable 20, the sample 15 held in each of the measuring chips 10 can be measured again.

In the surface plasmon resonance measurement apparatus, as described above, a plurality of measuring chips 10 are supported by the turntable 20 and are sequentially located at the measuring position by moving the turntable 20. Therefore, the samples 15 held in the sample holding portions 13 of the measuring chips 10 can be successively measured by movement of the turntable 20. Thus, the surface plasmon resonance measurement apparatus of the first embodiment is capable of measuring a great number of samples 15 in a short time.

In the measuring chip 10 according to the first embodiment, the optical coupling of the dielectric block 11 with another dielectric block through an index-matching solution is not needed as had conventionally been done. Thus, the measuring chip 10 of the first embodiment is easy to handle and does not require an index-matching solution that would have a bad influence on environment.

Note that the sensing medium 14 fixed on the surface of the metal film 12 bonds to a specific substance in the sample 15. An example of a combination of a specific substance in the sample 15 and the sensing medium 14 is a combination of an antigen and an antibody. In that case, an antigen-antibody reaction can be detected, based on the angle θₛₚ at which ATR takes place.

Next, a description will be given of the manufacturing method of the present invention for manufacturing the measuring chip 10.

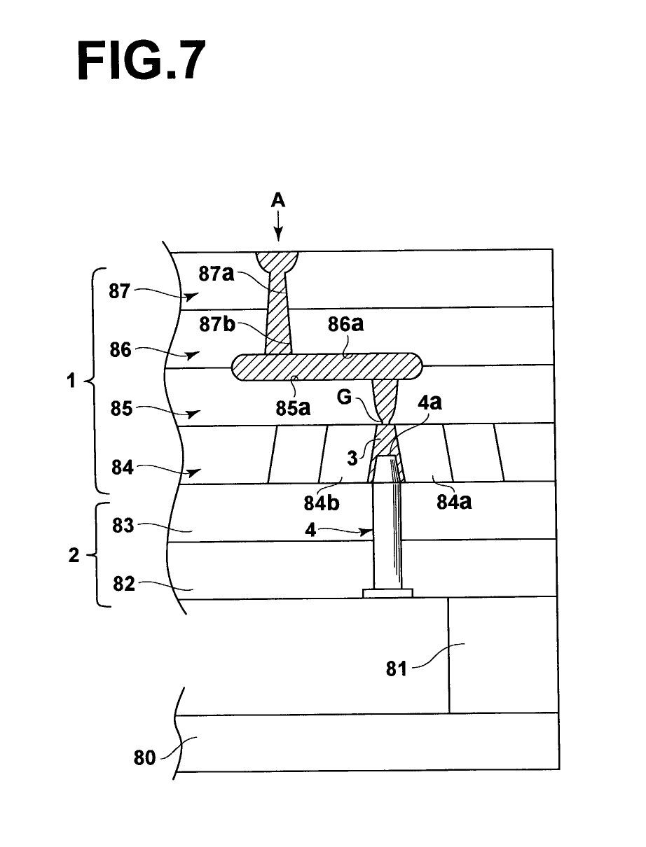

FIG. 7 shows is a schematic view of an example of an injection molding device for manufacturing the measuring chip 10 in accordance with the manufacturing method of the present invention. The injection molding device consists of a lower mold 2, and an upper mold 1 movable toward and away from the lower mold 2. The lower mold 2 is fixed to a vertically movable plate 80 through a spacer 81.

The lower mold 2 includes a receiving plate 82, a stopper plate 83 mounted on the receiving plate 82, and a pin 4 for molding the sample holding portion 13 (see FIG. 2) of the dielectric block 11. The upper mold 1 includes a movable plate 84 for bringing the upper mold 1 and the lower mold 2 into close contact in the vertical direction when the lower mold 2 is pressed upward against the upper mold 1, a runner plate 85, a runner stripper plate 86, and a stationary plate 87. The stationary plate 87 is fixed in the vertical direction. If the lower mold 2 is lowered a predetermined distance from the position shown in FIG. 7, the movable plate 84, runner plate 85, and runner stopper plate 86 move away from the stationary plate 87 while they are being separated from one another.

The movable plate 84 has slider blocks 84a and 84b, which forms a space 3 when they are moved horizontally so that they contact each other. If the upper mold 1 and the lower mold 2 are brought into contact with each other, the tip end of the pin 4 is inserted into the space 3. Note in FIG. 7 that spaces in which molten resin flows are hatched, as the space 3 is.

The top surface of the runner plate 85 and the bottom surface of the runner stopper plate 86 have runner grooves 85a and 86a, which engage each other when they are brought into contact with each other. The runner stopper plate 86 further has a lower resin introducing passage 86b, which is continuous to the upper runner groove 86a. The stationary plate 87 has an upper resin introducing passage 87a, which is communicated with the lower resin introducing passage 86a when the runner stopper plate 86 is brought into contact with the stationary plate 87.

If the upper mold 1 and the lower mold 2 are brought into contact with each other as shown in FIG. 7, and molten transparent resin is forced into the resin introducing passage 87a of the stationary plate 87 in the direction of arrow A, the resin is injected into the space 3 through a pin gate G. After the resin has been cooled and hardened, the upper mold 1 and the lower mold are moved away from each other and the slider blocks 84a and 84b are moved away from each other. As a result, the dielectric block 11 constituting the measuring chip 10 as shown in FIG. 3 is obtained.

When the dielectric block 11 is injection molded as described above, the gate G is disposed at a position that faces the tip end face 4a of the pin 4 which is a mold face for forming one surface 11a of the dielectric block 11. Therefore, there is no possibility that the mechanical strength of the dielectric block 11 will be reduced at a portion at which the resin merges. In addition, the occurrence of a weld in the one surface 11a of the dielectric block 11 is prevented. Furthermore, since there is no possibility that the pin 4 will be tilted in the horizontal direction by the pressure of the resin introduction, the shape of the dielectric block 11 is prevented from becoming incorrect.

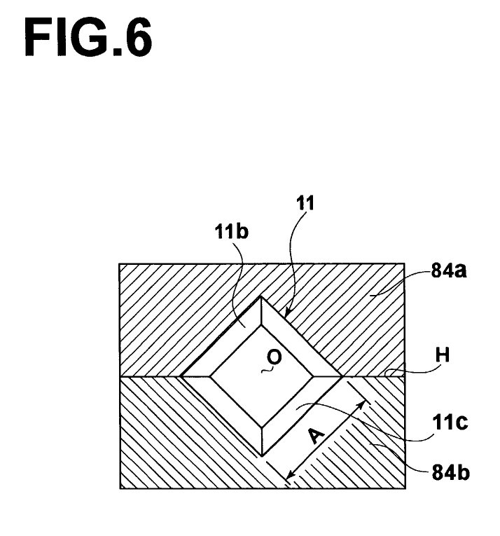

As shown in FIG. 6, the slider blocks 84a and 84b, which are used to mold the dielectric block 11, have horizontal sections parallel to the surface 11a on which the metal film 12 is formed. In this embodiment, the section parallel to the surface 11a on which the metal film 12 is formed is a regular tetragon. The injection molding is performed by employing two half molds 84a and 84b whose mating faces H are positioned outside two vertical angles of the regular tetragon which face each other across the center O of the regular tetragon.

If such two half molds 84a and 84b are employed, the light-transmitting areas of the light entrance surface 11c and light exist surface 11b can be prevented from being formed in the corners of the dielectric block 11, and the optical characteristics of the light-transmitting areas become excellent. The reason is as previously set forth in detail with reference to FIG. 6.

After the dielectric block 11 is formed in the above-described manner by injection molding, the metal film is formed on the aforementioned one surface 11a of the dielectric block 11. Furthermore, if the sensing medium 14 is fixed on the metal film 12, the measuring chip 10 as shown in FIG. 3 is obtained.

The measuring-chip manufacturing method of the present invention is not limited to the case where the dielectric block 11 with the above-described shape is formed by injection molding. The manufacturing method is likewise applicable to the case where a dielectric block with another shape is formed by injection molding. In addition, the gate G is not limited to the aforementioned pin gate. For example, it may be a fan gate, etc.

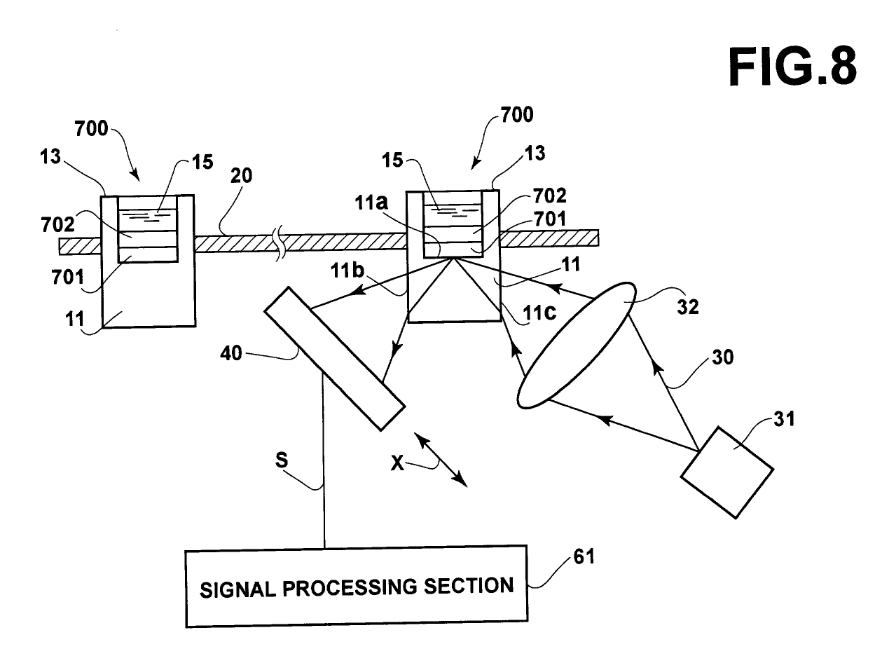

FIG. 8 shows a leaky mode measurement apparatus that employs measuring chips 700 manufactured in accordance with a second manufacturing method of the present invention. The leaky mode measurement apparatus basically has the same construction as the surface plasmon resonance measurement apparatus. The measuring chip 700 includes a cladding layer 701 formed on one surface (e.g., the top surface) of a dielectric body 11, and an optical waveguide layer 702 formed on the cladding layer 701.

The dielectric block 11 is formed, for example, from the aforementioned resin. The cladding layer 701 is formed into the shape of a thin film by employing a dielectric or metal (such as gold, etc.) lower in refractive index than the dielectric block 11. The optical waveguide layer 702 is also formed into a thin film by employing a dielectric, which is higher in refractive index than the cladding layer 91, such as polymethylmethacrylate (PMMA). The film thickness of the cladding layer 701 is 36.5 nm in the case where it is formed from a thin gold film. The film thickness of the optical waveguide layer 72 is about 700 nm in the case where it is formed from PMMA.

In the leaky mode measurement apparatus, if a light beam 30 emitted from a laser light source 31 strikes the cladding layer 701 through the dielectric block 11 at incidence angles greater than a critical angle at which total internal reflection (TIR) occurs, the light beam 30 is totally reflected at the interface 11a between the dielectric block 11 and the cladding layer 701. However, the light with a specific wave number, incident on the optical waveguide layer 702 through the cladding layer 701 at a specific incidence angle, propagates through the optical waveguide layer 702 in a waveguide mode. If the waveguide mode is excited in this manner, most of the incident light is confined within the optical waveguide layer 702, and consequently, ATR occurs in which the intensity of the light totally reflected at the interface 11a drops sharply.

The wave number of the light propagating through the optical waveguide layer 702 depends upon the refractive index of the sample 15 on the optical waveguide layer 702. Therefore, the refractive index of the sample 15 and the properties of the sample 15 related to the refractive index can be measured by finding the above-described specific incidence angle θₛₚ at which ATR takes place. A signal processing section 61 quantitatively analyzes a specific substance in the sample 15, based on the above-described principle. The result of analysis is displayed on a display section (not shown).

When forming the measuring chip 700, the dielectric block 11 of the measuring chip 700 can be injection-molded by the above-described manufacturing method of the present invention. Therefore, the same advantages as the case of FIG. 1 can be obtained.

Although the present invention has been described with reference to the preferred embodiments thereof, the invention is not to be limited to the details given herein, but may be modified within the scope of the invention hereinafter claimed.

What is claimed is:

1. A method of manufacturing a measuring chip which comprises
a dielectric block, and
a thin film layer, formed on one surface of said dielectric block, for placing a sample thereon;
said measuring chip being employed in a measurement apparatus which utilizes attenuated total reflection and comprises
a light source for emitting a light beam,
an optical system for making said light beam enter said dielectric block at various angles of incidence so that a condition for total internal reflection is satisfied at an interface between said dielectric block and said thin film layer, and
photodetection means for detecting the intensity of said light beam totally reflected at said interface to detect attenuated total reflection;
said dielectric block being formed from resin as a single block whose section parallel to said one surface is a polygon, and which includes an entrance surface through which said light beam enters said dielectric block, an exit surface through which said light beam emerges from said dielectric block, and said one surface on which said thin film layer is formed; and
said thin film layer being integrated with said dielectric block; implemented by the step of:
forming said dielectric block by injection molding, using two half molds whose mating faces are positioned outside two apex angles of said polygon which face each other across the center of said polygon.

2. A method of manufacturing a measuring chip which comprises
a dielectric block, and
a thin film layer comprising a metal film, formed on one surface of said dielectric block, for placing a sample thereon;
said measuring chip being employed in a measurement apparatus which utilizes attenuated total reflection and comprises
a light source for emitting a light beam,
an optical system for making said light beam enter said dielectric block at various angles of incidence so that a condition for total internal reflection is satisfied at an interface between said dielectric block and said metal film, and
photodetection means for detecting the intensity of said light beam totally reflected at said interface to detect attenuated total reflection due to surface plasmon resonance;
said dielectric block being formed from resin as a single block whose section parallel to said one surface is a polygon, and which includes an entrance surface through which said light beam enters said dielectric block, an exit surface through which said light beam emerges from said dielectric block, and said one surface on which said metal film is formed; and
said thin film layer being integrated with said dielectric block; implemented by the step of:
forming said dielectric block by injection molding, using two half molds whose mating faces are positioned outside two apex angles of said polygon which face each other across the center of said polygon.

3. A method of manufacturing a measuring chip which comprises
a dielectric block, and
a thin film layer comprising a cladding layer formed on one surface of said dielectric block, and an optical waveguide layer, formed on said cladding layer, for placing a sample thereon;
said measuring chip being employed in a measurement apparatus which utilizes attenuated total reflection and comprises
a light source for emitting a light beam,
an optical system for making said light beam enter said dielectric block at various angles of incidence so that a condition for total internal reflection is satisfied at an interface between said dielectric block and said cladding layer, and
photodetection means for detecting the intensity of said light beam totally reflected at said interface to detect attenuated total reflection due to the excitation of a waveguide mode at said optical waveguide layer;
said dielectric block being formed from resin as a single block whose section parallel to said one surface is a polygon, and which includes an entrance surface through which said light beam enters said dielectric block, an exit surface through which said light beam emerges from said dielectric block, and said one surface on which said cladding layer is formed; and
said thin film layer being integrated with said dielectric block; implemented by the step of:
forming said dielectric block by injection molding, using two half molds whose mating faces are positioned outside two apex angles of said polygon which face each other across the center of said polygon.

4. The method as set forth in claim 1, wherein said polygon is a regular polygon in which the number of sides is an even number.

5. The method as set forth in claim 2, wherein said polygon is a regular polygon in which the number of sides is an even number.

6. The method as set forth in claim 3, wherein said polygon is a regular polygon in which the number of sides is an even number.

7. The method as set forth in claim 1, wherein said resin comprises a cycloolefin polymer.

8. The method as set forth in claim 2, wherein said resin comprises a cycloolefin polymer.

9. The method as set forth in claim 3, wherein said resin comprises a cycloolefin polymer.

10. A measuring chip manufacured by the method as set forth in claim 1.

11. A measuring chip manufactured by the method as set forth in claim 2.

12. A measuring chip manufactured by the method as set forth in claim 3.

13. The measuring chip as set forth in claim 10, wherein said dielectric body has a sample holding portion for holding a sample on said thin film layer.

14. The measuring chip as set forth in claim 11, wherein said dielectric body has a sample holding portion for holding a sample on said thin film layer.

15. The measuring chip as set forth in claim 12, wherein said dielectric body has a sample holding portion for holding a sample on said thin film layer.
